(19) United States
(12) Patent Application Publication
(10) Pub. No.: US 2003/0030326 A1
(43) Pub. Date: Feb. 13, 2003

(54) Distributed power and supply architecture

(75) Inventors: Krishna Shenai, Naperville, IL (US); Erik A. McShane, Lockport, IL (US)

Correspondence Address: Robert J. Irvine, McDonnell Boehnen Hulbert & Berghoff, 32nd Floor, 300 S. Wacker Drive, Chicago, IL, 60606, US

(73) Assignee: Shakti Systems, Inc.

(21) Appl. No.: 10/217,840

(22) Filed: Aug. 12, 2002

Related U.S. Application Data
(60) Provisional application No. 60/311,575, filed on Aug. 10, 2001.
(60) Provisional application No. 60/337,837, filed on Nov. 5, 2001.
(60) Provisional application No. 60/337,479, filed on Nov. 5, 2001.
(60) Provisional application No. 60/338,510, filed on Nov. 5, 2001.

(51) Int. Cl. H02J 1/12

(52) U.S. Cl. 307/21; 307/29

(57) ABSTRACT

A power distribution management apparatus for supplying power to two or more loads includes a power and clock distribution controller capable of determining voltage, current and clock signal frequency targets for the loads. The apparatus also includes two or more power sources responsive to the controller so as to be selectively coupled with the loads to provide the target voltage and current to the loads. The power sources have switching frequencies of at least one megahertz. The apparatus further includes two or more clock signal sources responsive to the controller and coupled with the loads so as to provide clock signals to the loads at the target frequencies.

### PRIORITY AND RELATED APPLICATIONS

The present patent application claims priority under 35 U.S.C. §119(e) to (i) U.S. Provisional Patent Application Serial No. 60/311,575 entitled “Dynamic Power and Performance Management Architecture”; filed on Aug. 10, 2001, the full disclosure of which is incorporated herein by reference; (ii) U.S. Provisional Patent Application Serial No. 60/337,837 entitled “Novel DC-DC Step-Down Converter with Resonant Gate Drive”; filed on Nov. 5, 2001, the full disclosure of which is incorporated herein by reference; (iii) U.S. Provisional Patent Application Serial No. 60/337,479 entitled “Monolithic DC-DC Converter with Current Control for Improved Performance”; filed on Nov. 5, 2001, the full disclosure of which is incorporated herein by reference; (iv) U.S. Provisional Patent Application Serial No. 60/338,510 entitled “Monolithic Multi-Slice Synchronous Buck Converter” filed on Nov. 5, 2001, the full disclosure of which is incorporated herein by reference. This application is also related to concurrently filed Patent Applications: (i) Ser. No. ______, attorney docket no. 02-743-A entitled “LOGIC STATE TRANSITION SENSOR CIRCUIT”, the full disclosure of which is herein incorporated by reference; (ii) Ser. No. ______, attorney docket no. 02-485-A entitled “HYBRID DATA COMPARATOR” the full disclosure of which is herein incorporated by reference; (iii) Ser. No. ______, attorney docket no. 02-718-A entitled “CURRENT DERIVATIVE SENSOR”, the full disclosure of which is herein incorporated by reference.

### FIELD OF INVENTION

The present invention relates to power supply systems and, more particularly, to frequency and voltage tuning of distributed power supply systems.

### BACKGROUND

One common consideration in the design of electrical and/or electronic systems or components, such as, for example, personal computers or semiconductor components (hereafter “electronics”), is a trade off between performance and power consumption. In this regard, reductions in the power consumption of such electronics typically translate into a corresponding reduction in their performance, which is generally undesirable. Such reductions in performance are typically due, at least in part, to the fact that current approaches for power reduction are not particularly well suited to address the dynamic power and performance characteristics of complex electronics. Current approaches for balancing performance and power reduction in electronics may include: voltage scaling, selectively disabling circuitry, frequency scaling, bulk voltage-frequency scaling and quasi-static voltage-frequency scaling.

Voltage scaling, which is typically associated with advances in technology, produces diminishing returns with further technology advancement due to the relationship of power to the square of the voltage. Additionally, voltage scaling is typically quasi-static, which does not address dynamic performance considerations. Selective disabling of circuitry, while resulting in power reduction associated with the disabled circuitry, is an on-off (binary) approach and, therefore, also does not address dynamic performance considerations. Frequency scaling is typically done on a global system level using a quasi-static approach. Again, such an approach is not well suited to address dynamic power and performance concerns. Likewise, bulk voltage-frequency scaling and quasi-static voltage-frequency scaling are typically employed on a global system level and, therefore, may not adequately address dynamic performance and power consumption characteristics of complex electronics. Therefore, alternative approaches for balancing power consumption reduction and performance may be desirable.

### SUMMARY

A power distribution management apparatus for supplying power to two or more loads includes a power and clock distribution controller capable of determining voltage, current and clock signal frequency targets for the loads. The apparatus also includes two or more power sources responsive to the controller, so as to be selectively coupled with the loads to provide the target voltage and current to the loads. The power sources have switching frequencies of at least one megahertz. The apparatus further includes two or more clock signal sources responsive to the controller and coupled with the loads so as to provide clock signals to the loads at the target frequencies.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanying drawings in which:

FIG. 1 is a schematic diagram illustrating a prior frequency scaling circuit;

FIG. 2 is a schematic diagram illustrating a prior bulk voltage/frequency scaling circuit;

FIG. 3 is a schematic diagram illustrating a prior quasi-static voltage/frequency scaling circuit;

FIG. 4 is a schematic diagram illustrating an embodiment of a power distribution management apparatus in accordance with the invention; and

FIG. 5 is a graph illustrating normalized power savings that may be realized employing embodiments of the invention versus prior approaches.

### DETAILED DESCRIPTION

In the following detailed description, numerous specific details are set forth in order to provide a thorough understanding of the invention. However, it will be understood that the present invention may be practiced without these specific details. In other instances, well-known methods, procedures, components and circuits have not been described in detail, so as not to obscure the present invention.

As was previously indicated, current approaches for balancing performance and power consumption of electrical and/or electronic systems or components (hereafter “electronics”) may result in a poor trade off between performance and consumed power. As was also indicated, a number of various techniques for addressing this trade off exist. However, these techniques have certain drawbacks.

One approach that has been used to reduce power in complex electronics is technology and voltage scaling. Because power consumption (P) of such electronics is typically related to capacitance (C), voltage (V) and frequency of operation (f) as P=CV²f, reductions in power supply voltage may result in reductions in consumed power. Historically, many electronic systems and components operated with power supply voltages of five volts. As technologies, such as semiconductor manufacturing processes, have advanced, power supply voltages have decreased to the one-volt to one and one-half-volt range. While such decreases have produced significant power savings due to the squared relationship of voltage to power, such a technique is limited in its future efficacy, as supply voltage levels may not decrease to same extent as technologies continue to advance. For example, a reduction from 3.3 V to 1.5 V may produce a much larger reduction in power consumption than a reduction from 1.5 V to 1.0 V due, at least in part, to the relationship of power consumption to the square of the voltage.

Another technique that has been used to reduce power of complex electronics is to selectively disable certain parts of the electronics system and/or components that may be idle during certain operations. Such an approach is typically accomplished by halting the clock signal to portions of circuitry being disabled, thus reducing the power consumed. While such a technique may be effective for reducing power consumption, it is a purely on-off approach that may not address the dynamic performance and power consumption characteristics of complex electronics.

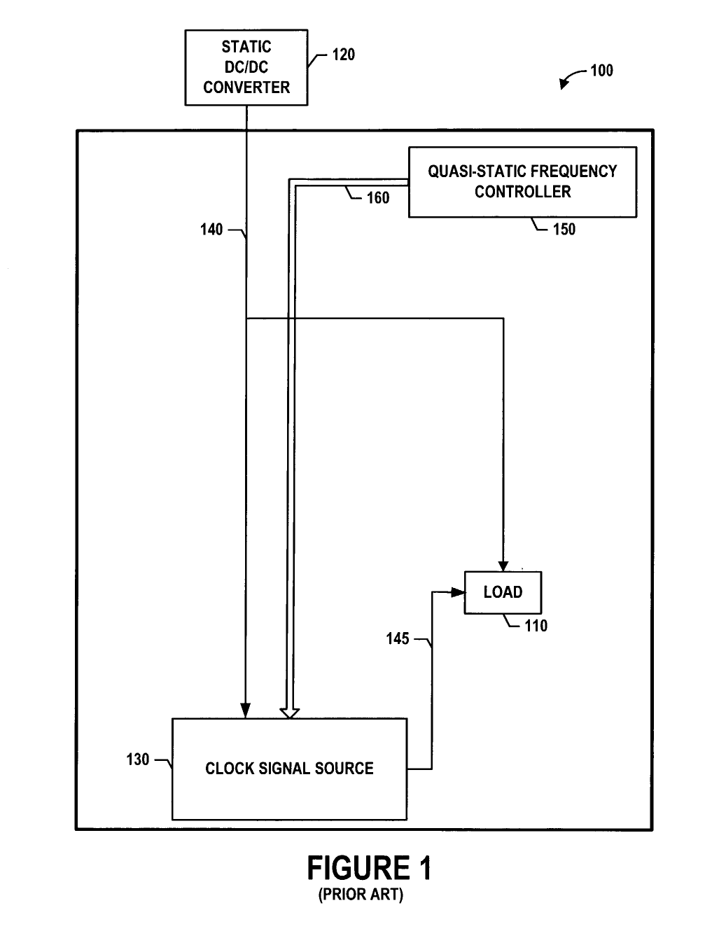

Referring now to FIG. 1, a schematic diagram illustrating a prior frequency-scaling circuit 100, which may balance performance and power consumption in a coarse manner is shown. Frequency scaling circuit 100 may include a load 110, to which power is to be supplied. Load 110 may be an electronic system, such as a personal computer, a semiconductor component, or any other electronic device or component. For circuit 100, static DC/DC converter 120 may supply voltage and current to load 110, as well as to clock signal source 130, via static voltage supply bus 140. Frequency scaling circuit 100 may further include quasi-static frequency controller 150, frequency tuning bus 160, and clock signal distribution bus 145. As will be discussed below, such a technique may produce roughly linear scaling in performance versus power consumption.

As was indicated above, such an approach may not address the dynamic performance and power consumption characteristics of complex electronics. For example, because frequency scaling with circuit 100 is applied globally, the balance between performance and power consumption must also be made globally. As a result, certain portions of load 110 may be operating at a frequency above that which is preferred and, therefore, be consuming more power than is preferred. Likewise, certain portions of load 110 may be operating at a frequency below that which is preferred and, therefore, may not be performing as preferred, or required. As a result, the entire device or component must operate at a frequency no lower than any given single component may require. Thus, the frequency scaling approach shown in FIG. 1 may not adequately address the balance between performance and power consumption for complex electronics in at least these respects.

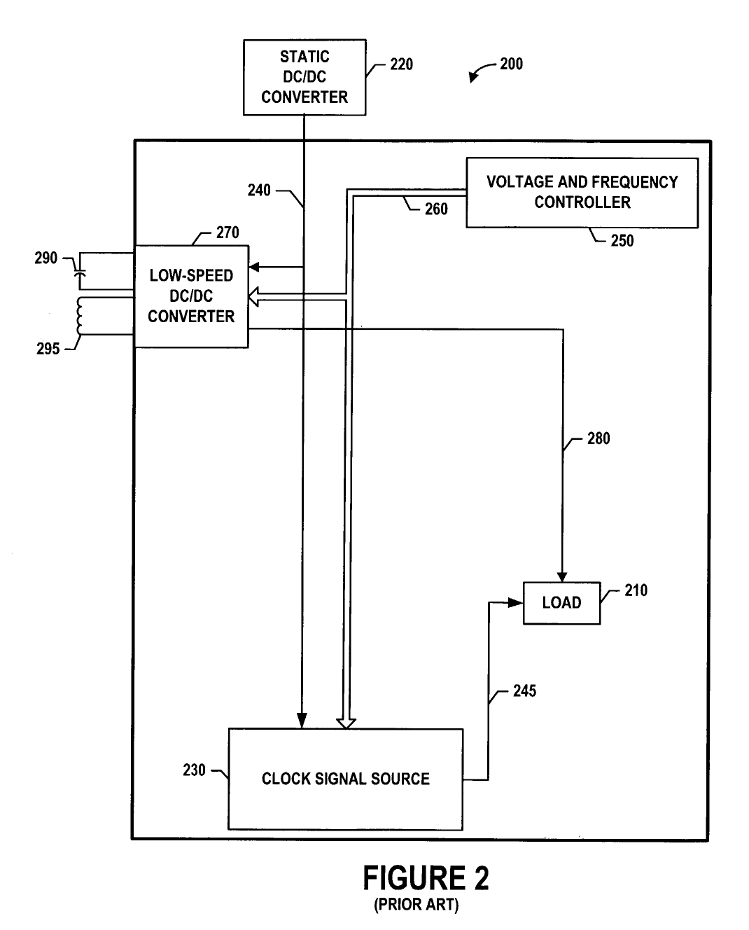

Referring now to FIG. 2, a schematic diagram of a prior bulk voltage/frequency (VF) scaling circuit 200 is shown. Bulk VF scaling circuit 200 may include load 210, static DC/DC converter 220, clock signal source 230, static voltage supply bus 240, and clock distribution bus 245 in similar fashion as frequency-scaling circuit 100. Circuit 200 may also include voltage and frequency controller 250, and voltage and frequency control bus 260, which may correspond with elements 150 and 160 of circuit 100. Circuit 200 may further include low-speed DC/DC converter 270, supplying a DC voltage supply to a load 210 via line 280. In this context, low-speed means that DC/DC converter 270, which may be a switch-type, regulated DC/DC converter that may be operated with a switching frequency on the order of 15 kilohertz. In this regard, DC/DC converter 270 may regulate voltage potentials supplied to it from external static DC/DC converter 220.

Circuit 200 also includes external reactive components, such as a capacitor 290 and an inductor 295, to provide voltage and current wells to be used by DC/DC converter 270 in supplying voltage and current to load 210. However, due, at least in part, to the fact that DC/DC converter 270 is regulating voltage globally and has a switching frequency in the kilohertz range, capacitor 290 and inductor 295 may be relatively large components (greater than one microfarad (μf) and one microhenry (μh), respectively. Thus, the performance of DC/DC converter 270 may be limited due, at least in part, to the response time of such relatively large reactive components.

While circuit 200 may be used to scale both voltage and frequency for load 210, such scaling is applied on a global level, as was the case with frequency scaling circuit 100. In this respect, circuit 200 may not adequately address the performance and power consumption characteristics of load 210. For example, certain portions of load 210 may be operating at voltages and/or frequencies that are above or below that which are preferred for balancing performance and power consumption for load 210. Therefore, those portions of load 210 may be consuming more power than is preferred, or not performing as preferred or required.

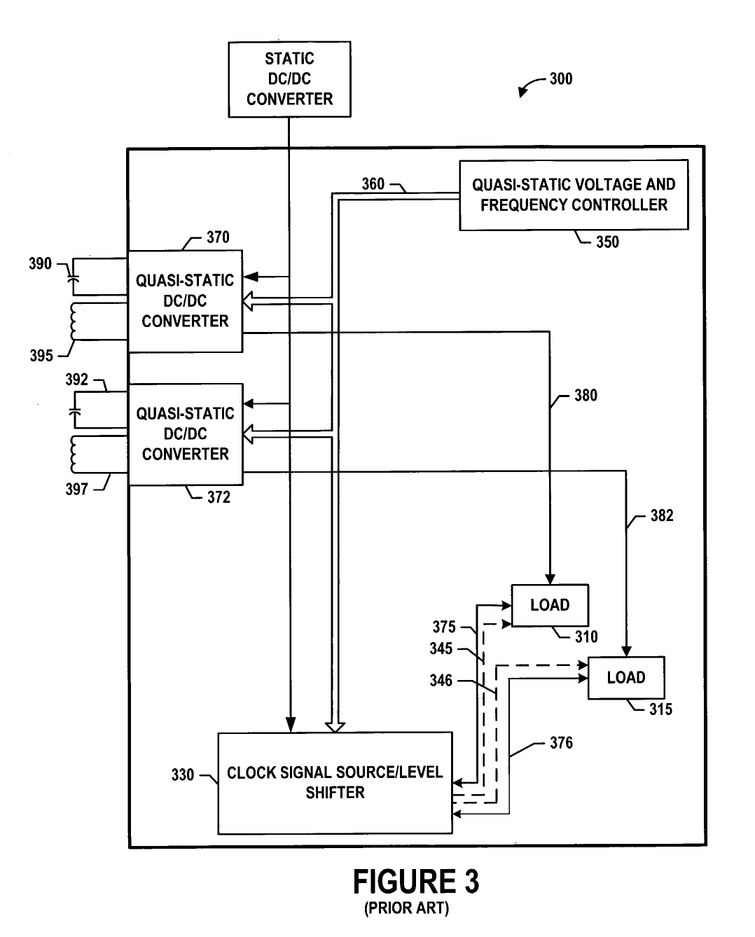

Referring now to FIG. 3, a schematic diagram of a prior quasi-static VF scaling circuit 300 is shown. Circuit 300 may include components corresponding with those shown in FIGS. 1 and 2 and, for the sake of brevity, those components will not be discussed further herein except in the respects that they differ from their counterparts in circuits 100 and 200. In this respect, circuit 300 may include two loads, load 310 and 315, which may be coupled with quasi-static DC/DC converters 370 and 372 via regulated voltage buses 380 and 382, respectively. An example of such a configuration may be a microprocessor component with an associated cache memory. In this regard, the microprocessor and the cache memory may operate at different supply voltages. This may be due, at least in part, to the fact that each component may be manufactured using a different manufacturing process, such as successive semiconductor process generations, as is common.

Clock signal source/level shifters 330 may globally supply a clock signal to loads 310 and 315 on clock signal lines 345 and 346, respectively. However, clock signal source/level shifter 330 may also include circuitry to modify the voltage level of electrical signals, such as the clock signals and signals communicated between load 310 and 315 via signal lines 375 and 376 when they are operating at different voltage levels. Such level shifting techniques are known, and may reduce the effect of noise on the communication of electrical signals between loads 310 and 315. As is shown in FIG. 3, signal lines 375 and 376 are bi-directional signal lines to allow electrical signals to be transmitted in both directions between loads 310 and 315 via clock signal source/level shifter 330.

Quasi-static controller 350 may communicate with DC/DC converters 370 and 375 via control bus 360 to establish preferred voltages for loads 310 and 315 based on user defined parameters or a specific application being conducted by loads 310 and 315. Likewise, controller 350 may communicate with clock signal source/level shifter 330 to establish a preferred clock signal frequency for loads 310 and 315. Controller 350 may also configure the level shifter portion of clock signal source/level shifter 330 based on the preferred voltages established for loads 310 and 315. Because circuit 300 includes two regulated quasi-static DC/DC converters, 370 and 375, circuit 300 may include additional reactive components, such as capacitor 392 and inductor 397 to provide additional voltage and current storage capability, as was previously described.

Circuit 300, as has been discussed with respect to circuits 100 and 200, may also not adequately address the balance between performance and power consumption for complex electronics. In this respect, quasi-static control of clock signal source/level shifter 330 and low-speed DC/DC converters 370 and 375 may result in certain portions of loads 310 and 315 operating at voltages and/or frequencies that are above or below that which are preferred for balancing performance and power consumption. Therefore, those portions of loads 310 and 315 may be consuming more power than is preferred, or not be performing as preferred. Based on the foregoing, alternative approaches for balancing power consumption and performance of electronics are desirable.

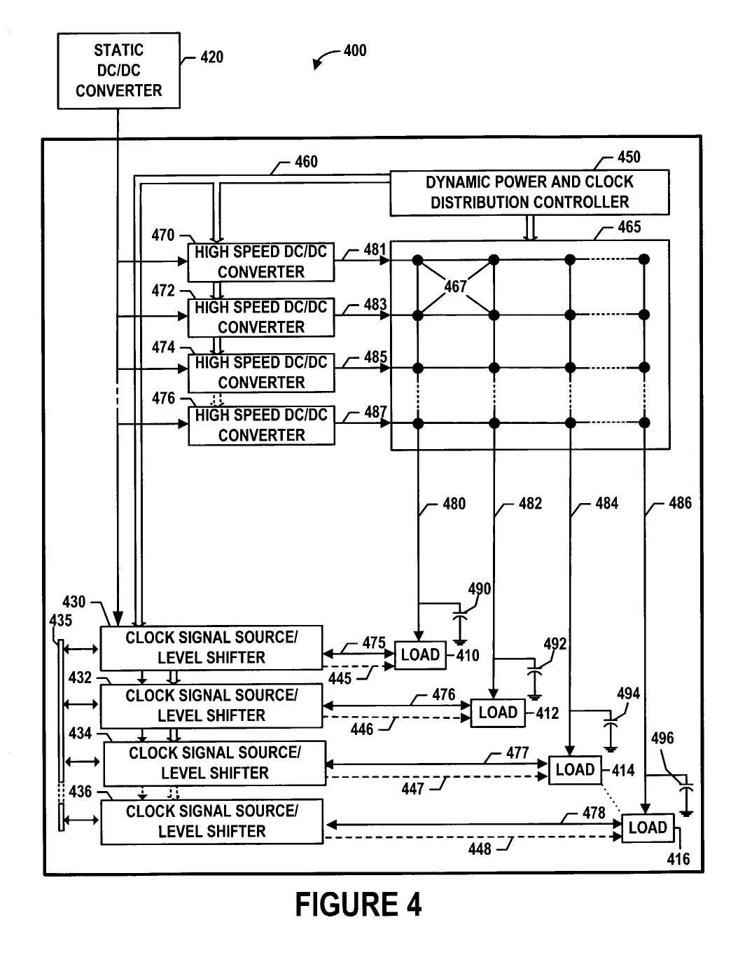

Referring now to FIG. 4, an embodiment of a power distribution management circuit 400 in accordance with the invention is shown. Circuit 400 may for be used to balance power consumption and performance for plural loads 410, 412, 414 and 416, though the invention is not so limited and fewer or additional loads may be included with circuit 400. Loads 410-416 may be individual components, functional blocks of a single component or independent systems. Typical loads may include an analog to digital converter utilizing comparators as described in U.S. patent application Ser. No. ______, attorney docket no. 02-485-A entitled “HYBRID DATA COMPARATOR”. Other loads may include RF power amplifiers as used in cellular phones, LCD displays, TFT displays, and the like as used in cellular phones and personal digital assistant devices, digital cameras, etc. Still further examples may include components or subsystems of a microprocessor or microcontroller such as cache memory, register files, arithmetic logic units (ALU), integer units, instruction pipeline circuitry, hardware multipliers, floating point circuits, non-volatile memory units, or circuitry clusters, such as those that may be defined within an application specific integrated circuit (ASIC).

Power and clock distribution controller 450 may be capable of determining voltage, current and clock signal frequency targets for the plural loads. Controller 450 may comprise logic circuitry for making such determinations, including state machines, combinational or sequential logic circuits, and other well-known controller circuit implementations. Alternatively, controller 450 may comprise software instructions for determining the voltage, current and frequency targets based, on information provided by circuitry included with controller 450, which may indicate an amount of circuit activity for each of the loads. That is, control algorithms may run on a separate microcontroller, or using microcode operating on a host processor.

In this regard, software programs may be configured to inform the controller of specific hardware performance requirements as application programs typically have different processing requirements. For example, word processing programs may require more integer operations than floating point operations. In a preferred embodiment, the software programs need not make determinations of specific sub-system (load cluster) requirements. Rather, it is preferred that the controller 450 make determinations based stored data relating to the particular application, and/or actual measured performance, and/or user-provided preference data. In alternative preferred embodiments, the software may be designed for operation on a system having a power management architecture as described herein, and may be configured to specify subsystem requirement parameters for use by controller 450. Preferably, the parameters provided by the software may still be regarding as guidelines or initial parameter settings, and the controller preferably still measures actual subsystem performance and makes dynamic determinations of actual performance versus required performance, and further adapts voltage and frequency parameters of the various subsystems.

Therefore, controller 450 may communicate with DC/DC converters and clock signal source/level shifters associated with each “load” and establish appropriate operating voltage and frequency values. Other applications, such as three-dimensional rendering programs (e.g. video games) may be more floating-point intensive. Controller 450 may, for such an application, establish an alternative set of operating conditions for various loads (e.g. floating point unit and integer unit) for such applications.

In an alternative preferred embodiment, one or more logic state transition sensor circuits (not shown) or current derivative sensor circuits (not shown) may be included with controller 450 to provide circuit activity information for loads 410-416. Controller 450 may communicate voltage and frequency requirements via bus 460. Additionally, information from DC/DC converters and clock circuits, such as those described below, may also be communicated to controller 450 via bus 460. Such information may include circuit activity information, as described herein, information from clock circuits regarding lock state, such as for phase-locked-loop circuits, for example, or any other information controller 450 might employ when managing power and clock distribution.

Such sensor circuits are described in detail in concurrently filed patent application Ser. No. ______, attorney docket no. 02-743-A entitled “LOGIC STATE TRANSITION SENSOR CIRCUIT” and attorney docket no. 02-718-A entitled “CURRENT DERIVATIVE SENSOR”, The invention is, of course, not limited to the circuits described in those applications, and other techniques for determining circuit activity exist. Briefly, however, such a circuit may determine a number of logic transitions in a predetermined time period. Controller 450 may then use that information to determine voltage, current, and frequency targets for loads 410-416. For example, certain processing activities of software running on a microprocessor may utilize various subsystems more heavily. By sensing high levels of activity of certain strategically identified nodes, the requirements for those subsystems may be identified as requiring higher (or lower) clocking frequency, and hence higher (or lower) operating voltages. In an alternative embodiment, controller 450 may comprise sensing circuits connected to critical-nodes (nodes that tend to limit the rate at which a given operation may be completed) and responsively adjust (lower) frequencies of other non-critical signal paths, or adjust (increase) the frequency of the circuit elements containing the critical node paths.

Circuit 400 may also include plural high-speed DC/DC converters 470, 472, 474 and 476. Again, the invention is not so limited and fewer or addition converters may be included. DC/DC converters 470-476 may be responsive to controller 450, such that they are selectively coupled with loads 410-416 to provide the respective target voltages and currents to the loads. As was previously indicated, converters 470-476 are preferably high-speed DC/DC converters, which may have switching frequencies of at least one megahertz. Such power supplies are described in U.S. Pat. No. 5,959,439 to Krishna Shenai, the present inventor.

DC/DC converters 470-476 may take a number of other forms as well. For example they may comprise high-speed, regulated DC/DC converters that include a low-drop-out linear converter (not shown). Alternatively, DC/DC converters 470-476 may comprise high-speed, regulated DC/DC converters that include a switch-mode inductor-based step-up converter and a switch-mode inductor-based step-down converter a switch-mode charge-pump converter, or a switch-mode capacitor converter (none of which are specifically shown). Such converters may utilize well-known pulse width modulation or pulse frequency modulation to control the switching elements of the DC/DC converters. However, such converters still preferably operate at a switching frequency high enough to allow the incorporation of the converter onto a single die without the need for external inductive or capacitive elements. Of course, the invention is not limited in scope to the specific types of converters discussed above, and other DC/DC converter configurations are possible.

Because DC/DC converters 470-476 may be coupled with relatively smaller loads, as compared to prior approaches, they may include relatively smaller reactive components, such as a capacitor of less than one-hundred nanofarads and an inductor of less that one-hundred nanohenries. In addition, the preferred high-speed converters operate at a switching frequency of at least one megahertz, which also contributes significantly to lowering the size and/or number of capacitive and inductive components. Because DC/DC converters 470-476 may include smaller reactive components, they may be integrated monolithically (single die or component) with loads 410-416, such as on a common integrated circuit, for example. The DC/DC converters may be placed strategically with a large die near the specific load clusters for which they provide power.

As an alternative, the DC/DC converter including the inductive and capacitive components may be fabricated on a separate die, and then combined within an IC package with circuits (load clusters) on other dies. That is, DC/DC converters 470-476 may comprise discrete monolithic power supplies, which are electrically coupled with loads 410-416 or may be monolithically integrated together on a single die, which is then coupled with loads 410-416 on one or more die. Additionally, circuit 400 may include local charge storage capacitors 490, 492, 494 and 496, which may function to stabilize the voltage delivered to each load by DC/DC converters 470-476.

Circuit 400 may further include plural clock signal sources/level shifters (clock/shifters) 430, 432, 434 and 436, which may be coupled with a logic bus 435 for communication with other devices or components. Clock/shifters 430-436 may also be responsive to controller 450 and coupled with loads 410-416 so as to provide clock signals via clock signal buses 445, 446, 447 and 448 to the loads at the target frequencies, which may be determined by controller 450, as has been previously described. As was previously discussed, clock/shifters 430-436 may also include circuitry that allows electrical signal communication between loads operating at varying target voltages via signal buses 475, 476, 477 and 478. Such an approach may improve the noise tolerance of such electrical signal communication.

Additionally, clock/shifters 430-436 may comprise, phase-locked-loop circuits, delay-locked-loop circuits, or combinational logic circuits for supplying clock signals to loads 410-416. These circuits may operate at an integer multiplication, a half-integer multiplication or a quarter-integer multiplication of a reference clock signal. Controller 450 may provide the reference clock signal, though the invention is not so limited. Alternatively, these circuits may operate at an integer division, a half-integer division and a quarter-integer division of the reference clock signal. Such configurations may allow for synchronous communication between loads 410-416, as opposed to asynchronous communication, which may be undesirable.

Circuit 400 may further include a cross-bridge connection network 465. Network 465 may be responsive to controller 450 so as to selectively couple DC/DC converters 470-476 with loads 410-416 via connection network 465's nodes 467 and voltage supply lines 480, 481, 482, 483, 484, 485, 486 and 487. For this embodiment, network 465 may comprise a row-column addressable matrix, or any other suitable cross-bridge apparatus.

The cross-bridge network 465 provides a means of dynamically partitioning the load clusters by combining certain load clusters into a common load. In this regard, a single DC/DC converter may be coupled to multiple loads through connection network 465, such as in a situation where a single DC/DC converter is able to provide the power (e.g. voltage times current) consumed by the multiple loads, or it is desired to simultaneously provide a single voltage to multiple clusters. In this scenario, the controller 450 may determine voltage and frequency requirements of the load clusters and responsively couple the load clusters to appropriately programmed DC/DC converters. Alternatively, multiple DC/DC converters may be coupled with a single load, such as in the situation where a load may consume more power than one DC/DC converter is able to provide. Further in this regard, one or more DC/DC converters may operate in a multi-slice configuration as described more fully in U.S. Provisional Patent Application Serial No. 60/338,510 entitled “Monolithic Multi-Slice Synchronous Buck Converter” filed on Nov. 5, 2001.

While not shown in FIG. 4, it may be advantageous to distribute clock signals via a connection network that may be similar in structure to network 465. In this respect, for example, clock signal source/level shifter 430 may be coupled with multiple loads. This may allow for a reduction in the number of circuit components used in such a configuration, which may result in a reduction in manufacturing cost and a further reduction in the power consumption of such components.

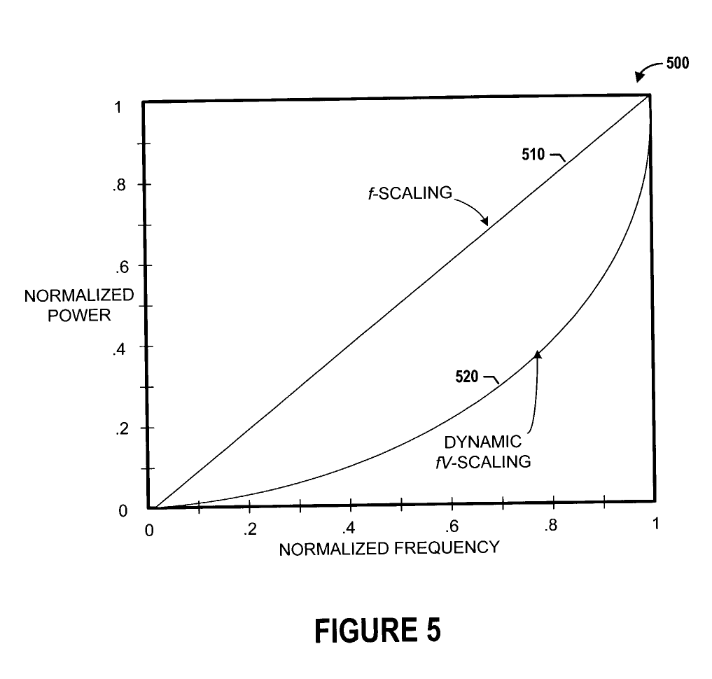

Referring now to FIG. 5, a graph 500 showing a comparison of normalized power versus normalized frequency for frequency scaling versus combined frequency-voltage scaling is shown. Line 510 illustrates the relationship of power to frequency for a frequency scaling approach for a single logic gate or load. In comparison, line 520 illustrates the relationship of power to frequency for a combined frequency-voltage scaling approach for the same logic gate or load. From this graph, the benefits of a combined frequency-voltage scaling approach are apparent.

Because prior approaches apply frequency scaling, voltage scaling, or frequency-voltage scaling on a bulk basis (to a single complex component or system), they are not able to realize the demonstrated power consumption savings that may be achieved by embodiments of the invention disclosed herein. In this regard, bulk scaling typically only allows scaling to the extent of the maximum of the minimum voltage and minimum frequency requirements of each portion of such a complex system. In this situation, one portion of circuitry may determine the operating voltage and frequency for the entire load when it is possible that the balance of the load could operate at lower voltages and frequencies without any resultant negative performance impact.

For embodiments of the invention, such as illustrated in FIG. 4, such loads may be partitioned. With the use of high-speed, regulated DC/DC converters, as previously described, each load of a partitioned (or dynamically partitioned) complex electronic system may function at voltage and frequency values that allow the load to realize the power savings shown in FIG. 5 by line 520. That is, some non-critical components may be provided with clock and voltage settings that allow them to operate lower down (further to the left on curve 520), while only those load clusters that must operate at a higher level of performance operate at a higher point on curve 520. In this respect, the aggregate power savings realized by embodiments of the invention may be substantially greater than prior bulk and quasi-static approaches.

As illustrated herein, embodiments of the invention may be used to dynamically control small loads by employing high-speed DC/DC converters, and rapidly vary clock signals. The amount of power consumption (based on frequency and voltage settings) of various loads may be determined through circuit measurements, or other software control, as has been previously described. In some situations, such as logic speed path circuits, voltage may be the primary operating condition that a frequency and voltage controller, such as 450, may use to adjust circuit operating conditions. In other situations, such as data transfer operations, sequential operations, etc., frequency may be the primary operating parameter established by a controller. In such a situation, the required frequency may then be used to determine the necessary supply voltage to support the desired switching frequency.

Furthermore, embodiments of the invention may also employ techniques such as disabling portions of circuitry, or managing larger loads in a bulk fashion, depending on the particular embodiment. Such approaches may result in further improvements in power consumption reduction, as well as reductions in complexity in electronic systems in which they are employed.

While certain features of the invention have been illustrated and described herein, many modifications, substitutions, changes and equivalents will now occur to those skilled in the art. It is, therefore, to be understood that the appended claims are intended to cover all such modifications, changes and variations as fall within the true spirit of the invention.

What is claimed is:

1. A power distribution management apparatus for supplying power to a plurality of loads, the apparatus comprising:
a power and clock distribution controller capable of determining voltage, current and clock signal frequency targets for the plural loads;
plural power sources responsive to the controller so as to be selectively coupled with the loads to provide the target voltage and current to the loads, wherein the power sources have switching frequencies of at least one megahertz; and
plural clock signal sources responsive to the controller and coupled with the loads so as to provide clock signals to the loads at the target frequencies.

2. The apparatus of claim 1, wherein the plural power sources comprise regulated power sources coupled with at least one static power supply.

3. The apparatus of claim 2, wherein the regulated power sources comprise a low-drop-out linear converter.

4. The apparatus of claim 2, wherein the regulated power sources comprise at least one of a switch-mode inductor-based step-up converter and a switch-mode inductor-based step-down converter.

5. The apparatus of claim 2, wherein the regulated power sources comprise a switch-mode charge-pump converter.

6. The apparatus of claim 2, wherein the regulated power sources comprise a switch-mode capacitor converter.

7. The apparatus of claim 1, wherein the power sources include at least one of a capacitive reactive component of less than one-hundred nanofarads and an inductive reactive component of less that one-hundred nanohenries.

8. The apparatus of claim 1, wherein the plural power sources comprise one or more monolithic power supplies embodied on a common integrated circuit with the plural loads.

9. The apparatus of claim 1, wherein the plural power sources comprise discrete power supplies, which are electrically coupled with an integrated circuit that includes the plural loads.

10. The apparatus of claim 1, wherein the plural clock signal sources comprise phase-locked-loop circuits.

11. The apparatus of claim 1, wherein the plural clock signal sources comprise delay-locked-loop circuits.

12. The apparatus of claim 1, wherein the plural clock signal sources comprise combinational logic circuits.

13. The apparatus of claim 1, wherein the plural clock sources provide at least one of an integer multiplication, a half-integer multiplication and a quarter-integer multiplication of a reference clock signal.

14. The apparatus of claim 1, wherein the plural clock sources provide at least one of an integer division, a half-integer division and a quarter-integer division of a reference clock signal.

15. The apparatus of claim 1, further comprising a cross-bridge connection network responsive to the controller so as to selectively couple the power sources with the plural loads via the connection network.

16. The apparatus of claim 15, wherein the connection network comprises a row-column addressable matrix.

17. The apparatus of claim 1, further comprising level-shifting circuitry, so as to allow electrical signal communication between loads of the plural loads operating at varying target voltages.

18. The apparatus of claim 1, wherein the controller comprises a critical-node activity determination circuit, wherein at least one power source and one clock signal source are controlled by the controller based on an activity level as determined by the critical-node activity determination circuit.

19. The apparatus of claim 1, wherein the controller comprises machine executable instructions for determining the voltage, current and frequency targets based, at least in part, on one or more use conditions for one or more of the plural loads.

20. The apparatus of claim 1, wherein the controller comprises a critical-node current-sensing circuit, wherein at least one power source and one clock signal source are controlled by the controller based, at least in part, on a current level as determined by the critical-node current-sensing circuit.

21. A method for managing power distribution to a plurality of loads, the method comprising:
determining one or more use conditions of the loads, wherein the use conditions include voltage, current and clock signal frequency targets for the loads;
modifying the operating conditions for one or more clock signal sources coupled with the plural loads based, at least in part, on the use conditions, so as to provide clock signals to the loads at respective target frequencies; and
modifying operating conditions for one or more power sources coupled with the plural loads based, at least in part, on the use conditions, so as to provide the target voltages and currents to the loads.

22. The method of claim 21, wherein determining the one or more use conditions comprises determining one or more critical-node activity levels of the plural loads.

23. The method of claim 21, wherein determining the one or more use conditions comprises determining an amount of current consumption for one or more of the plural loads.

24. The method of claim 21, wherein determining the one or more use conditions comprises determining a function being performed by at least one load of the plural loads.

25. The method of claim 21, wherein modifying the operating conditions for one or more power sources comprises at least one of stepping-up an output voltage and stepping-down an output voltage.

26. The method of claim 21, wherein modifying the operating conditions for one or more power sources comprises coupling one or more power sources with one or more loads via a connection network.

27. The method of claim 21, further comprising electrically communicating between one or more loads.

28. The method of claim 27, wherein electrically communicating comprises shifting the level of one or more electrical signals.

29. The method of claim 21, wherein modifying the operation of one or more clock signal sources comprises at least one of increasing an oscillation frequency and decreasing the oscillation frequency.

30. An electronic system comprising:
a plurality of loads;
a power and clock distribution controller capable of determining voltage, current and clock signal frequency targets for the loads;
plural power sources responsive to the controller and coupled with the plural loads so as to provide the target voltages and currents to the loads; and
plural clock signal sources responsive to the controller and coupled with the plural loads so as to provide clock signals to the loads at the target frequencies.

31. The system of claim 30, wherein the plurality of loads each comprises an associated local charge storage capacitor.

32. The system of claim 30, further comprising a plurality of level-shifting circuits coupled with the controller and the plural loads, the level-shifting circuitry being capable of adjusting an amplitude of an electrical signal communicated between loads.

33. The system of claim 30, further comprising a static power supply coupled with the plural power sources, wherein the plural power sources are regulated power sources.

34. The system of claim 30, further comprising a connection network responsive to the controller and coupled with the power sources and the loads, wherein the connection network is capable of coupling, in parallel, two or more power sources with one or more loads.

35. A power distribution management apparatus for supplying power to a plurality of loads, the apparatus comprising:
a power and clock distribution controller capable of determining voltage, current and clock signal frequency targets for the plural loads;
plural regulated power sources coupled with at least one static power supply, the regulated power sources being responsive to the controller so as to be selectively coupled with the loads to provide the target voltage and current to the loads, wherein the power sources have switching frequencies of at least one megahertz;
plural clock signal sources responsive to the controller and coupled with the loads so as to provide clock signals to the loads at the target frequencies;
a cross-bridge connection network responsive to the controller, so as to selectively couple the power sources with the plural loads via the connection network;
and level-shifting circuitry, so as to allow electrical signal communication between loads of the plural loads operating at varying target voltages.
